(19) United States
(12) Patent Application Publication
(10) Pub. No.: US 2008/0073404 A1
(43) Pub. Date: Mar. 27, 2008

(54) Portable device for manipulating carpet tack strip

(76) Inventor: Matthew O. Hylton, Summerfield, FL (US)

Correspondence Address: Leander F. Aulisio, 320 23rd Street #705, Arlington, VA, 22202, US

(21) Appl. No.: 11/504,610

(22) Filed: Aug. 16, 2006

(51) Int. Cl. B25C 5/02

(52) U.S. Cl. 227/110

(57) ABSTRACT

A portable hand-held device for installing carpet tack strip on a floor, the device comprising a hollow housing, a hammer bar for reciprocal movement within the housing, a grip and a trigger, an alignment sleeve and a pneumatic motor, whereby a nail is enveloped by the alignment sleeve both prior to and during a hammering operation, the nail being employed to secure the carpet tack strip to the floor.

### BACKGROUND OF THE INVENTION

1. Field of the Invention

The present invention relates to a portable hand-held tool that is a device for installation of wall-to-wall carpet. Before the carpet is stretched to the wall and firmly secured to the floor, a carpet tack strip having a plurality of small upwardly extending carpet nails is firmly secured to the floor. The carpet tack strip is nailed to the floor so that it will not move when the carpet is attached. Manipulation of a carpet tack strip, which can be made of wood or plastic, requires a cutting operation to obtain a desired length of strip, and then a hammering operation to secure the strip to the floor. Usually, different tools are employed for each separate operation. If a chiseling operation is required, another separate tool is employed.

2. Discussion

Installation of wall-to-wall carpet is a tedious and time-consuming process. Even a skilled worker finds the job time-consuming and less efficient because he must employ so many various types of tools. Manipulation of carpet tack strip has always proved to be a difficult operation because many times the work is performed in confined spaces. Damage to walls and floors is a constant problem.

The device of the present disclosure allows for efficient and expedient manipulation of carpet tack strip. A skilled worker would benefit from a single power tool that performs multiple operations such as cutting, hammering and chiseling.

U.S. Patent Application Publication No. 2003/0168491 to Goodwin relates to an upright nail gun comprising a handle assembly with an elongated shaft, a trigger at the distal end of the shaft and a nail gun at the proximal end of the shaft. A handle assembly for attachment to a nail gun is also disclosed.

U.S. Pat. No. 6,427,339 issued to Andrew on Aug. 6, 2002, relates to an electrical metal cutting device for use in difficult-to-reach areas. The device includes an L-shaped housing; a motor within the housing, said motor being connected to an outside power source; a power cylindrical bore with an inwardly extending shaft; a power piston connected to the cylindrical bore; and a cutting blade secured to the power piston.

U.S. Pat. No. 5,417,294 issued to Salher on May 23, 1995, relates to a hammer device that includes an impact tool driven by pressurized fluid.

U.S. Pat. No. 4,204,625, issued to Glenn on May 27, 1980, relates to an apparatus for installing a tack strip, the apparatus including a hammer means and a cutting means. Two cutting means can be employed, one on each side of the hammer.

U.S. Pat. No. 4,030,654, issued to York on Jun. 21, 1977, relates to a hammer device having a reciprocally movable hammer shaft, and useful for driving nails in a carpet strip.

### SUMMARY OF THE INVENTION

The present disclosure relates to a portable hand-held tool that is a device that can be adapted for cutting, hammering or chiseling. The device comprises a hollow body that contains a pneumatic motor. The pneumatic motor drives a hammer bar in a piston-like reciprocating fashion. The end of the hammer bar contains a replaceable tip made of a magnetic material for holding nails prior to hammering. In an alternative embodiment, the entire hammer body can be magnetized for holding nails prior to hammering. The proximal end of the hammer is coupled with a reciprocating piston driven by the pneumatic motor. The coupling can be done by means of reciprocating springs of variable length and resistance. When a trigger is pulled, the motor is activated as by an external air compressor, and the hammer bar moves back and forth in a hammering action. The hammering action is focused at a specific point by means of an alignment sleeve. The alignment sleeve is located at the distal end of the air hammer, and envelopes the nail to be hammered. The nail can be attached to the end of the hammer gun by means of magnetic attraction, or the nail can be pre-positioned in the carpet tack strip by the manufacturer of the strip. The alignment sleeve is attached to the hammer gun by means of a spring or a series of springs.

When a cutting operation is desired, a cutting blade is swung into operational position. The device comprises a cutting blade that is attached to a moveable arm. The moveable arm can be an elastic spring or an expandable length. The cutting blade is replaceable. In a preferred embodiment, the cutting blade is attached to a cutting bit that stabilizes the blade for reciprocal movement. The moveable arm is secured to the device by means of a swivel joint. The swivel joint can be positioned on the hand-held tool on the alignment sleeve. The joint allows for the cutting blade to be placed in an inoperable position that is to the side of the hammer. Manual movement of the arm can position the cutting blade underneath the hammer in a snugly fitting relationship. The cutting blade is then in operational position. In a preferred embodiment, the end of the cutting bit that does not contain the blade fits snugly with the tip of the hammer. A snug fit can be obtained by employing a depression in the cutting bit that accepts the hammer in a male-female relationship. Other means such as a clamping system can be employed.

### BRIEF DESCRIPTION OF THE DRAWINGS

FIG. 1 is a side-view of a representative power tool of the present invention. A cutting blade and a chisel blade are shown in inoperable positions, with the hammer bar being in an operable position.

FIG. 2 is a representation of a side-view of a retrofitting device of the present invention. The device is attached to a commercial power tool. The cutting blade is in an inoperable position and the hammer bar is in an operable position.

FIG. 3 is a representation of functional parts of the power tool wherein the hammer bar is in the operable position and the cutting blade is in the inoperable position.

FIG. 4 is a representation of functional parts of the power tool wherein the cutting blade is in a snugly fitting relation with the hammer bar, and therefore in an operable position for cutting.

### DETAILED DESCRIPTION OF THE INVENTION

The present disclosure relates to a hand-held device that is powered by a pneumatic motor. The device is portable and can be easily transported. The devise has a generally L-shaped configuration wherein the base of the L is preferably the grip or handle for the hand. A trigger is within easy reach of the grip or handle. The trigger is used to activate the pneumatic motor that then drives the hammer bar, the blade or the chisel. Attached to the pneumatic motor is an air hose for connecting the pneumatic motor to an external source of pressurized air. The external source of compressed air can be powered by a gas powered engine, a battery, a fuel cell, an outlet for ac current, or the like. The vertical part of the L is a hollow body for receiving the pneumatic motor, the reciprocating springs and the hammer bar. The proximal end of the hammer bar is attached to the hollow housing by a spring or a series of springs. The distal end of the hammer shaft extends beyond the end of the hollow body. A replaceable magnetic tip is located at the distal end of the hammer shaft. The magnetic tip can be easily replaced when it becomes worn. Means of attaching the tip to the hammer shaft are well-known in the art and form no part of the present disclosure.

A cutting blade is fitted into a cutting bit in a removable fashion. The cutting bit is connected to a swivel joint positioned on an alignment sleeve by means of a moveable arm. The moveable arm can be a spring or a resilient material. The arm can be rotated manually to position the cutting blade directly below the hammer bar. This position negates the hammering action and allows for the cutting action. The tool becomes a cutting device when the cutting blade is moved to snugly fit into the end of the hammer bar that contains the magnetic tip. When the cutting action is no longer needed, the cutting blade can be rotated to the side of the device. It can be easily replaced when it is worn. In an alternative embodiment, the hammer shaft itself can be magnetized. A fully magnetized hammer shaft allows for easy and rapid pickup of nails and makes a replaceable magnetic tip unnecessary.

The positioning of the swivel joint on the device can be on the alignment sleeve. The moveable arm with cutting blade attachment (or any other attachment) is positioned on the alignment sleeve by means of a swivel joint. Preferably two swivel joints are employed to attach a pair of moveable arms to the alignment sleeve. In a more preferred embodiment, two swivel joints are employed to attach two pair of moveable arms to the alignment sleeve. A first pair of moveable arms connects a cutting blade to the alignment sleeve; and a second pair of moveable arms connects a chiseling blade to the same alignment sleeve. The design and function of the swivel joints are well known to one of ordinary skill in the art, and as such form no part of the present invention.

The moveable arms themselves can be adjustable in length either by means of springs or some other means. It is also within the scope of the present invention to employ arms that are nonadjustable, but that are of such dimensions that the auxiliary cutting blade or any other auxiliary piece fits snugly on the hammering end of the hammer bar.

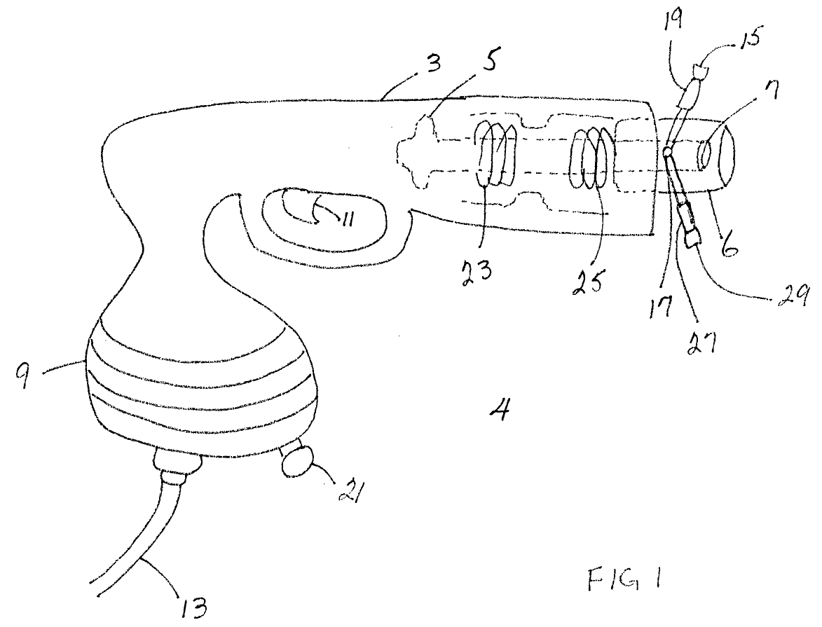

FIG. 1 is a representative drawing of a side view of a hand held power tool 4 having a generally L-shaped configuration for installation of wall-to-wall carpet. An air hose 13 connects the tool to an external source of compressed air (not shown). The external source of compressed air can be powered by gasoline, a source of AC current, a battery, a fuel cell or the like. The tool 4 is comprised of a handle 9 and an elongated hollow body 3. Located on the body 3 is a trigger 11 that activates a pneumatic motor (not shown). The pneumatic motor is disposed within the hollow body 3 near the trigger 11. The pneumatic motor is connected to the external source of compressed air as by air hose 13.

Located on the alignment sleeve 6 is a swivel joint 17 for connecting moveable arms 19 and 27 to the tool 4. Located at the distal end of the moveable connecting arms 19 and 27 is a cutting blade 15 and chiseling blade 29. Located within the hollow body 3 is a spring 23 for resiliently attaching a reciprocating hammer bar 5 to tool 4. The hammer bar 5 is useful for driving nails for securing a carpet tack strip. A replaceable magnetic head 7 is attached to the top of the hammer. The magnetic head 7 can hold and position a nail prior to hammering of the nail into the carpet tack strip. Both magnetic head 7 and cutting blade 15 are replaceable once they are in a worn condition. The chiseling blade 29 is also replaceable when in a worn condition.

The representation of FIG. 1 shows the cutting blade and the chiseling blade in a non-operational position and the hammer in an operational position. This position of the hand-held power tool is useful for securing a carpet tack strip to the floor by employing nails prior to attaching the carpet to the tack strip. Alignment sleeve 6 allows for accurate positioning of the hammer bar 5 over the nail head prior to and during the hammering action. The tool can be employed in areas where the hammering operation must be conducted at an angle, such as in positions under cabinets and the like. A nail can be hammered at an angle of up to 45 degrees by the power tool of the present invention. This is because the alignment sleeve 6 functions as a focusing aid for the hammering action.

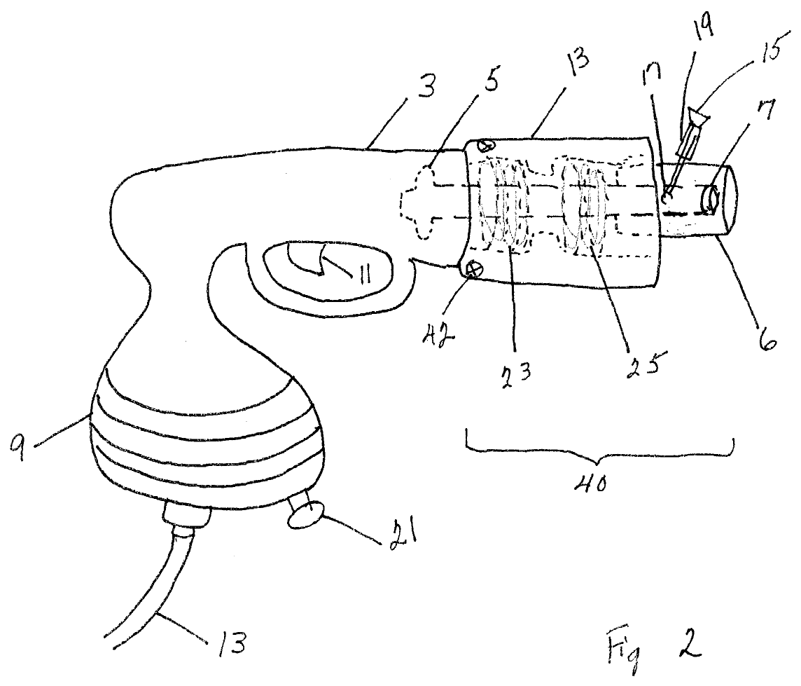

FIG. 2 is a representation of a side view of a retrofitting device of the present invention. The retrofitting device can upgrade a commercial hand-held power tool. Commercial hand-held power tools have a generally L-shaped configuration. They are employed for securing and cutting carpet tack strip used in the installation of wall-to-wall carpet. The power tool comprises a handle 9 and a hollow barrel 3. A trigger 11 is attached to the barrel 3 for turning a pneumatic motor (not shown) on and off. The pneumatic motor is disposed within the hollow barrel 3 at a position near the trigger 11. The pneumatic motor is coupled to an air compressor by means of an air hose 13. The power supply for the air compressor can be an electric generator, a source of ac current, a battery, a fuel cell or the like. A hammer bar 5 is reciprocally attached to a spring 23 that is attached to the inside of the hollow barrel 3. When power is applied, the hammer can move in a piston-like fashion within the hollow barrel. The distal end of the hammer extends beyond the end of the hollow barrel 3. Attached directly to the distal end of the hammer bar 5 is a replaceable magnetic tip 7. The retrofitting device 40 comprises a swivel means 17 located on an alignment sleeve 6 at a distance removed from the replaceable magnetic tip 7. The swivel means 17 connects a cutting blade 15 to the alignment sleeve 6 as by moveable arm 19. The moveable arm 19 can be a spring or an elastomeric material. The alignment sleeve 6 is resiliently attached to a hollow housing 13 by means of spring 25. Alternatively, a series of springs can be employed to attach the alignment sleeve 6 to the housing 13. The hollow housing 13 connects directly to the commercial power tool by a connecting means. Preferably, the connecting means is a series of allen screws 42. Three allen screws are sufficient to attach the retrofitting device 40 to the power tool. More preferably, the connecting means is a threaded barrel for directly accepting a threaded bore extending from a commercial hand-held power tool. In the alternative, the connecting means can be a “fast clip”. The moveable arm 19 can be manually adjusted to swing the cutting blade 15 into operational position. When in operational position, the cutting blade 15 fits snugly over the magnetic tip 7 of the hammer bar 5.

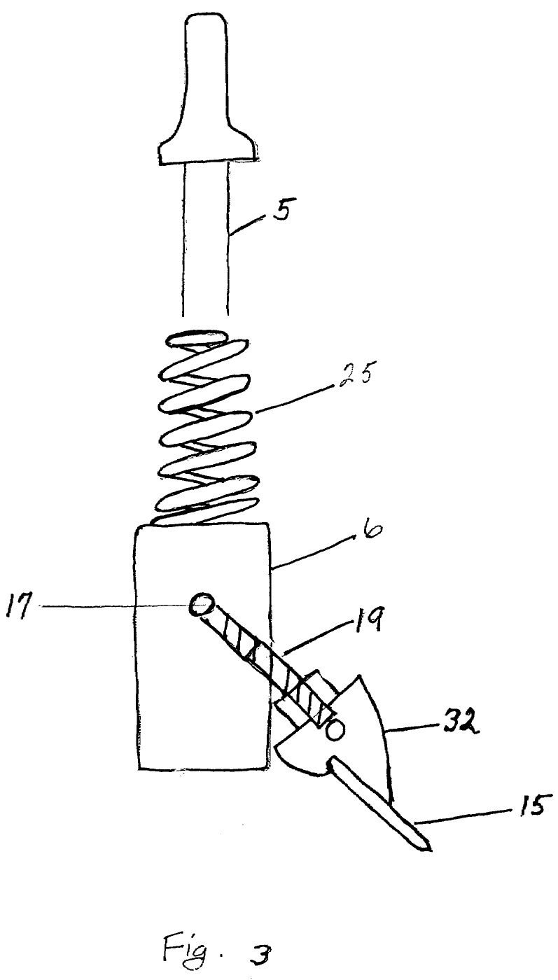

FIG. 3 is a drawing that represents the functional elements of the hand-held power tool. A spring 25 is attached to an alignment sleeve 6 at the proximal end of sleeve 6 for reciprocal movement of the hollow alignment sleeve 6. A hammer bar 5 is positioned inside the alignment sleeve 6, said hammer bar 5 passing through the spring 25. When power is supplied to the tool, the hammer bar 5 moves back and forth in a piston-like reciprocal motion. Attached to the alignment sleeve 6 is a moveable arm 19. The arm 19 can be a spring or some other expandable length such as an elastomeric material. The moveable arm 19 is connected to the sleeve 6 by means of swivel joint 17. At the distal end of moveable arm 19 is connected a cutting blade 15 and a mount 32 for the cutting blade 15. When worn, the cutting blade 15 can be removed from the mount 32 and replaced with a new blade.

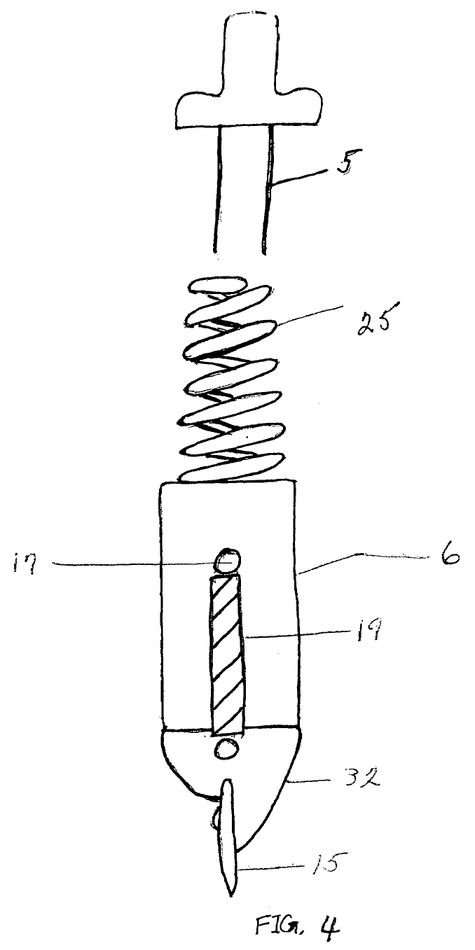

FIG. 4 is a representational drawing of the functional elements of a hand-held power tool useful in installing wall-to-wall carpet. As FIG. 3 is a representation of an inoperable position for the cutting blade, so FIG. 4 represents the operable position for the cutting blade 15. A spring 25 is attached to the alignment sleeve 6 so that the alignment sleeve 6 is moveable with respect to the hand-held power tool. The cutting blade in FIG. 4 has been manually moved to snugly fit over the hammering tip of hammer bar 5. When the tool is powered as by compressed air, the hammer bar 5 undergoes reciprocal movement and allows for a cutting action by blade 15. When cutting blade 15 is worn, it can be removed from the cutting blade mount 32 and replaced with a new blade.

The present invention can be employed to retrofit an existing power tool that has a reciprocating piston. The present retrofitting device can be attached to the power tool by a variety of means. Depending on the brand of power tool, the device can be attached by allen screws at the upper part of the housing 13 to the power tool. Alternatively, the present device, including hollow housing 13, alignment sleeve 6, springs 23 and 25, hammer bar 5, can be attached to the existing power tool by means of threaded screws. Other attachment means, such as a clamping means, are also contemplated in the present invention. The present device, used in upgrading an existing power tool, comprises a hollow housing 13 in the shape of a cylindrical tube that has a distal end and a proximal end. An attachment means is attached to the proximal end of the hollow housing. The attachment means provides for attachment of the device to the prior art power tool. A hammer bar 5 is positioned for reciprocal movement within the housing 13. Reciprocating springs 23 and 25, located inside the hollow housing, allow for the connection of the hammer bar 5 and the alignment sleeve 6 in a moveable fashion to the hollow housing 13. The hammer bar 5 can be used for a hammering operation, wherein the alignment sleeve 6 focuses the hammer shaft 5 to a nail to be hammered. This focusing can even be done at an angle of up to 45°. A cutting bit 32 is attached to the outside of the alignment sleeve 6 by means of a movable arm 19. A cutting blade 15 is secured to the cutting bit 32 for stabilizing the blade for reciprocal movement. The movable arm 19 is secured to the power tool by means of a swivel joint 17. The swivel joint 17 can be positioned on the alignment sleeve 6. The swivel joint 17 allows for the cutting blade 15 to be placed in an inoperable position that is to the side of the hammer 5. Manual movement of the arm can then position the cutting bit 32 directly underneath the hammer 5 in a snugly fitting relationship. The cutting blade 5 is then in operational position. The end of the cutting bit 32 that does not contain the blade 15 fits snugly with the distal end of the hammer 5. The snug fit can be obtained by employing a depression in the cutting bit 32 that accepts the distal end of the hammer (the hammering end) in a male-female relationship.

While the invention has been described by specific examples and embodiments, there is no intent to limit the inventive concept except as set forth in the following claims:

We claim:

1. A hand-held device for manipulating a carpet tack strip comprising:
(a) a hollow housing;
(b) a hammer bar for reciprocal movement within the housing, the hammer bar having a proximal end and a distal end;
(c) a hand-held grip and a trigger extending from the grip; said grip being operatively connected to the hollow housing;
(d) an alignment sleeve; and
(e) a pneumatic motor, the motor positioned within the hollow housing, wherein the alignment sleeve is operatively connected to the hollow housing in a reciprocating fashion and wherein the proximal end of the hammer bar is attached to a reciprocating piston extending from the pneumatic motor, whereby a nail is enveloped by the alignment sleeve both prior to and during a hammering operation.

2. A device according to claim 1 further comprising;
(f) an air hose;
(g) a cutting bit comprising a first end and a second end, the first end for receiving a cutting blade and the second end having a shape to fit snugly on the distal end of the hammer bar;
(h) an elastic arm extending from the cutting bit;
(i) a means for powering the device; and
(j) a swivel joint for connecting the elastic arm to the alignment sleeve; the swivel joint allowing for pendulum-type motion whereby the cutting blade can be in an operative reciprocating position and in an inoperative non-reciprocating position, the operative position being when the cutting bit fits snugly on the distal end of the hammer shaft.

3. A device according to claim 1 wherein the hammer bar has a cylindrical shape.

4. A device according to claim 2 wherein the means for powering the hammer bar is an air compressor.

5. A device according to claim 4 wherein the air compressor is powered by a member selected from the group consisting of electric generator, household electric current, fuel cell, storage battery, solar generator and combinations thereof.

6. A device according to claim 1 wherein the grip and the hollow housing are a one-piece molded unit.

7. A device according to claim 2 wherein the cutting bit has a cylindrical shape.

8. A device according to claim 1 wherein the hammer bar is fully magnetized.

9. A device according to claim 1 wherein a magnetic tip is operatively connected to the distal end of the hammer bar, the hammer bar being unmagnetized.

10. A device according to claim 1 wherein the alignment sleeve is operatively connected to the hollow housing by means of a spring.

11. A device according to claim 2 wherein the elastic arm is a spring.

12. A device according to claim 2 wherein the cutting blade is replaceable.

13. A device according to claim 2 wherein the air hose is connected at a first end to the hand-held device and at a second end to the air compressor.

14. A device for retrofitting a power tool having a reciprocating piston, the device comprising:
(a) a hollow housing in the shape of a cylindrical tube that has a distal end and a proximal end;
(b) a connecting means attached to the proximal end of the hollow housing, said means enabling attachment of the device to a reciprocating piston of a power tool;
(c) a hammer bar for reciprocal movement within the housing and having a first blunt end for hammering;
(d) a cutting bit comprising a sharp end and a second blunt end, the second blunt end having dimensions whereby said cutting bit fits snugly on the first blunt end of the hammer bar;
(e) an alignment sleeve;
(f) a first reciprocating spring located inside the hollow housing and operatively connecting the hammer bar to the hollow housing;
(g) a second reciprocating spring located inside inside the hollow housing and operatively connecting the alignment sleeve to the hollow housing;
(h) a swivel means for connecting the cutting bit to the alignment sleeve wherein the swivel means comprises an elastic arm and a swivel joint, the swivel means allowing for pendulum-type motion whereby the cutting bit can be in an operative reciprocating position and in an inoperative non-reciprocating position at different times, the operative position being when the cutting bit fits snugly on the first blunt end of the hammer bar.

15. A device according to claim 14 wherein the connecting means is a member selected from the group consisting of a plurality of allen screws, a plurality of clamping means and a threaded barrel.

16. A device according to claim 14 wherein the elastic arm comprises a spring.

17. An apparatus for retrofitting an air hammer comprising:
(a) a hammer bar comprising an elongated solid metal cylinder having a proximal end and a distal end, the cylinder having a flange near the proximal end;
(b) an alignment sleeve comprising a hollow metal cylinder having a primary end and a secondary end, both ends having an aperture that allows for reciprocal movement of the hammer bar;
(c) a housing unit comprising an elongated hollow metal cylinder having a first end and a second end, both ends having an aperture that allows for reciprocal movement of the hammer bar;
(d) a first attachment means for flexibly connecting the hammer bar to the housing unit, said first attachment means being a first flexible spring system;
(e) a second attachment means for flexibly connecting the alignment sleeve to the housing unit, said second attachment means being a second flexible spring system; and
(f) a third attachment means for connecting the housing unit to the air hammer, said housing unit being attachable to the air hammer at the first end of the housing unit, the third attachment means having a member selected form the group consisting of allen screws, a threaded barrel, fast clips and clamping means.

17. An apparatus according to claim 16 wherein the hammer bar comprises a forged steel shaft.

18. An apparatus according to claim 17 wherein the forged steel shaft is fully magnetized.

19. An apparatus according to claim 16 wherein the hollow housing comprises a metal housing.

20. An apparatus according to claim 16 wherein the alignment sleeve comprises a metal sleeve.
